(19) United States
(12) Patent Application Publication
(10) Pub. No.: US 2008/0225438 A1
(43) Pub. Date: Sep. 18, 2008

(54) Laminate for Suspension and Method for Producing Same

(75) Inventors: Takahiro Kuki, Chiba (JP); Hisayoshi Mukai, Chiba (JP); Teppei Nishiyama, Chiba (JP); Kazuhisa Urano, Chiba (JP)

Correspondence Address: OLIFF & BERRIDGE, PLC, P.O. BOX 320850, ALEXANDRIA, VA, 22320-4850, US

(73) Assignee: NIPPON STEEL CHEMICAL CO., LTD, Tokyo (JP)

(21) Appl. No.: 11/795,648

(22) PCT Filed: Feb. 27, 2006
(86) PCT No.: PCT/JP06/03541

§ 371 Date: Jul. 19, 2007

(30) Foreign Application Priority Data
Mar. 3, 2005 (JP) 2005-058456

(51) Int. Cl. G11B 5/60

(52) U.S. Cl. 360/235.1

(57) ABSTRACT

A laminate (20) for a suspension comprises a stainless steel foil (11), and an insulating layer (12) and a conductor layer (13) that are stacked in this order on the stainless steel foil (11). The stainless steel foil (11) contains a martensite phase in a volume fraction of 0.4 to 2.5 volume %. The insulating layer (12) is made of a polyimide resin, for example. The conductor layer (13) contains pure copper or a copper alloy, for example. The laminate (20) for a suspension is used for producing a wiring-integrated suspension that flexibly supports a slider including a magnetic head such that the slider is opposed to a recording medium.

### TECHNICAL FIELD

The present invention relates to a laminate for a suspension used for producing a wiring-integrated suspension that flexibly supports a slider including a magnetic head, and to a method for producing the same.

### BACKGROUND ART

In a hard disk drive, a slider including a magnetic head is flexibly supported by a suspension and is disposed to be opposed to a recording medium. When the recording medium rotates, a lift is generated for the slider due to an airflow passing between the recording medium and the slider, and the lift causes the slider to slightly fly over the surface of the recording medium. Therefore, mechanical properties, such as rigidity, of the suspension have a great influence on the flying height and the attitude of the slider.

Wiring is connected to the magnetic head included in the slider. The wiring is laid along the suspension. Conventionally, the wiring is attached to the suspension after the suspension is fabricated. However, attaching the wiring to the suspension in such a manner has disadvantages that the rigidity, air resistance and so on of the wiring can affect the flying height and the attitude of the slider and that it is impossible to simplify the step of connecting the wiring to the magnetic head.

To cope with this, a wiring-integrated suspension has been proposed in which the wiring is integrated with the suspension, as disclosed in Patent documents 1 and 2, for example. The wiring-integrated suspension has a patterned conductor layer formed over the suspension with an insulating layer therebetween. As a method for patterning the conductor layer, Patent document 1 discloses employing a laminate formed by stacking an insulating layer and a conductor layer in this order on a stainless steel foil, and patterning the conductor layer of this laminate by etching. As a method for patterning the conductor layer, Patent document 2 discloses employing a laminate formed by stacking an insulating layer on a stainless steel foil, and forming a patterned conductor layer on the insulating layer of this laminate by a technique such as sputtering or plating.
Patent document 1: WO 98/08216
Patent document 2: JP 10-270817A

### DISCLOSURE OF THE INVENTION

### Problems to be Solved by the Invention

As described above, laminates for suspensions used for producing wiring-integrated suspensions include one formed by stacking an insulating layer and a conductor layer in this order on a stainless steel foil, and one formed by stacking an insulating layer on a stainless steel foil. Conventionally, the laminate formed by stacking an insulating layer and a conductor layer in this order on a stainless steel foil has a problem that the laminate can warp after it is produced. The warpage of the laminate results in problems that the transfer path for laminates can be clogged with the warped laminate in the course of production of the suspension, and that the mechanical precision of the suspension can suffer degradation. Also, in the case of producing a suspension using the laminate formed by stacking an insulating layer on a stainless steel foil, there is the problem that the laminate can warp after the conductor layer is formed on the insulating layer of the laminate. In this case, too, there arises the problem of degradation in mechanical precision of the suspension.

It is an object of the present invention to provide a laminate for a suspension and a method for producing the same that are capable of suppressing the warpage of the laminate for a suspension used for producing a wiring-integrated suspension.

### Means for Solving the Problems

A laminate for a suspension according to the present invention is for use in producing a wiring-integrated suspension that flexibly supports a slider including a magnetic head such that the slider is opposed to a recording medium. The laminate for a suspension according to the present invention includes a stainless steel foil and an insulating layer stacked on the stainless steel foil, the stainless steel foil containing a martensite phase of 0.4 to 2.5 volume %.

A method for producing the laminate for a suspension according to the present invention includes the steps of selecting, as the stainless steel foil, one that contains a martensite phase of 0.4 to 2.5 volume %; and stacking the insulating layer on the stainless steel foil selected.

The laminate for a suspension or the method for producing the same according to the present invention enables suppression of the warpage of the laminate for a suspension when the conductor layer is stacked on the insulating layer, by the use of, as the stainless steel foil, one that contains a martensite phase of 0.4 to 2.5 volume %.

In the laminate for a suspension or the method for producing the same according to the present invention, the stainless steel foil may be made of austenitic stainless steel containing the martensite phase.

In the laminate for a suspension or the method for producing the same according to the present invention, the stainless steel foil may contain Ni of 7 to 13 weight % and Cr of 16 to 20 weight %.

In the laminate for a suspension or the method for producing the same according to the present invention, the insulating layer may be made of a polyimide resin.

In the laminate for a suspension or the method for producing the same according to the present invention, the stainless steel foil may have a thickness within a range of 10 to 100 μm, and the insulating layer may have a thickness within a range of 5 to 50 μm.

In the laminate for a suspension or the method for producing the same according to the present invention, the insulating layer may have a coefficient of linear thermal expansion within a range of 10×10⁻⁶ to 30×10⁻⁶.

In the laminate for a suspension or the method for producing the same according to the present invention, the insulating layer may have a first surface touching the stainless steel foil and a second surface opposite thereto, and the laminate for a suspension may further include a conductor layer disposed to touch the second surface of the insulating layer. In this case, the stainless steel foil may have a thickness within a range of 10 to 100 μm, the insulating layer may have a thickness within a range of 5 to 50 μm, and the conductor layer may have a thickness within a range of 5 to 50 μm. In addition, the insulating layer may have a coefficient of linear thermal expansion within a range of 10×10⁻⁶ to 30×10⁻⁶, and the conductor layer may have a coefficient of linear thermal expansion within a range of 10×10⁻⁶ to 30×10⁻⁶. In addition, the conductor layer may contain pure copper or a copper alloy.

### EFFECTS OF THE INVENTION

The laminate for a suspension or the method for producing the same according to the present invention enables suppression of the warpage of the laminate for a suspension when the conductor layer is stacked on the insulating layer, by the use of, as the stainless steel foil, one that contains a martensite phase of 0.4 to 2.5 volume %.

Other objects, features and advantages of the present invention will become fully apparent from the following description.

### BRIEF DESCRIPTION OF THE DRAWINGS

FIG. 1 is a cross-sectional view of part of a laminate for a suspension according to a first embodiment of the present invention.

FIG. 2 is a cross-sectional view of part of a laminate for a suspension according to a second embodiment of the present invention.

FIG. 3 is a top view of an example of a wiring-integrated suspension produced through the use of the laminate for a suspension according to the present invention.

FIG. 4 is an explanatory view illustrating a first form of warpage of a laminate for a suspension.

FIG. 5 is an explanatory view illustrating a second form of warpage of a laminate for a suspension.

FIG. 6 is a plot illustrating the relationship between the volume fraction of the martensite phase in the stainless steel foil and the coefficient of linear thermal expansion thereof in Examples and Comparative examples.

FIG. 7 is a plot illustrating the relationship between the volume fraction of the martensite phase in the stainless steel foil and the amount of warpage of the laminate in the Examples and the Comparative examples.

### EXPLANATIONS OF REFERENCE NUMERALS

1 . . . load beam; 2 . . . flexure; 3 . . . gimbal section; 4 . . . wiring; 10, 20 . . . laminate for a suspension; 11 . . . stainless steel foil; 12 . . . insulating layer; and 13 . . . conductor layer.

### BEST MODE FOR CARRYING OUT THE INVENTION

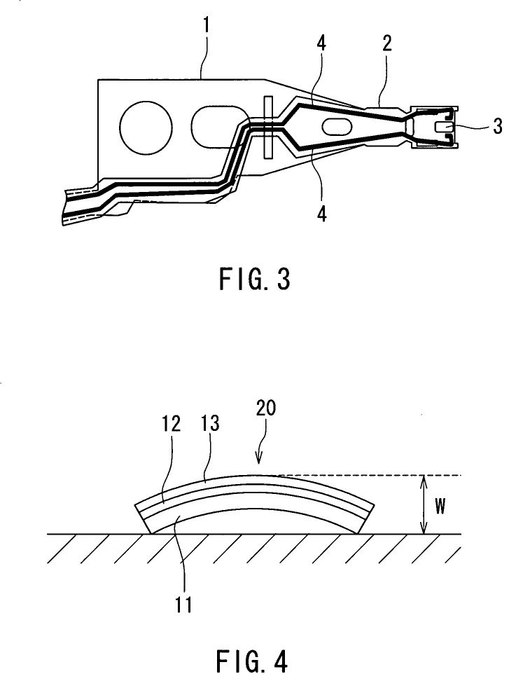

Embodiments of the present invention will now be described in detail with reference to the drawings. First, with reference to FIG. 3, a description will be made on an example of configuration of a wiring-integrated suspension produced through the use of a laminate for a suspension according to the present invention. FIG. 3 is a top view of the wiring-integrated suspension. This wiring-integrated suspension flexibly supports a slider including a magnetic head such that the slider is opposed to the recording medium.

The wiring-integrated suspension illustrated in FIG. 3 includes: a plate-spring-shaped load beam 1 formed of stainless steel, for example, and a flexure 2 attached to an end portion of the load beam 1. An end portion of the flexure 2 is designed so that a slider that is not shown and that includes a magnetic head is attached thereto. The flexure 2 provides the slider with an appropriate degree of freedom. At the portion of the flexure 2 to which the slider is to be attached, there is provided a gimbal section 3 for maintaining the attitude of the slider constant. The other end portion of the load beam 1 is designed to be attached to an actuator. The actuator drives the suspension so that the slider moves in a direction across the tracks of the recording medium. The flexure 2 includes wiring 4 having an end to be connected to the magnetic head. The laminate for a suspension according to the present invention is used for producing the flexure 2.

It should be noted that the configuration of the wiring-integrated suspension produced through the use of the laminate for a suspension according to the invention is not limited to the one illustrated in FIG. 3. For example, the wiring-integrated suspension may be provided with, in place of the load beam 1 and the flexure 2 of FIG. 3, a suspension body in which they are integrated. In this case, the suspension body includes the wiring 4. Then the laminate for a suspension according to the invention is used for producing the suspension body.

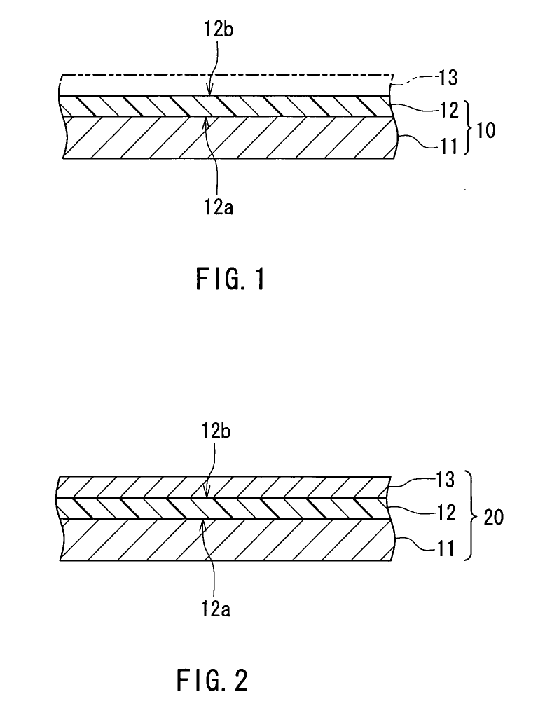

Now, with reference to FIG. 1 and FIG. 2, a laminate for a suspension (hereinafter simply referred to as laminate) according to each of a first and a second embodiment of the invention and a method for producing the same will be described.

FIG. 1 is a cross-sectional view of part of the laminate 10 according to the first embodiment. The laminate 10 according to the present embodiment includes a stainless steel foil 11, and an insulating layer 12 stacked on the stainless steel foil 11. The insulating layer 12 has a first surface 12a touching the stainless steel foil 11, and a second surface 12b opposite thereto.

The method for producing the laminate 10 according to this embodiment includes the step of stacking the insulating layer 12 on the stainless steel foil 11. How to stack the insulating layer 12 on the stainless steel foil 11 is not specifically limited. For example, the insulating layer 12 made of resin may be formed by casting on the stainless steel foil 11, or the insulating layer 12 may be formed by laminating a resin film on the stainless steel foil 11.

In the case of producing the flexure 2 or the suspension body through the use of the laminate 10 according to the present embodiment, a patterned conductor layer 13 is formed on the second surface 12b of the insulating layer 12. This patterned conductor layer 13 becomes the wiring 4. How to pattern the conductor layer 13 is not specifically limited. For example, after forming an unpatterned conductor layer 13 on the second surface 12b of the insulating layer 12, the conductor layer 13 may be patterned by etching, or a patterned conductor layer 13 may be formed by a technique such as sputtering or plating on the second surface 12b of the insulating layer 12. The laminate 10 is processed into a predetermined shape by a technique such as etching so as to become the flexure 2 or the suspension body.

FIG. 2 is a cross-sectional view of part of the laminate 20 according to the second embodiment. The laminate 20 according to the present embodiment includes: a stainless steel foil 11; and an insulating layer 12 and a conductor layer 13 stacked in this order on the stainless steel foil 11. The insulating layer 12 has a first surface 12a touching the stainless steel foil 11, and a second surface 12b opposite thereto, and the conductor layer 13 is disposed to touch the second surface 12b.

The method for producing the laminate 20 according to the present embodiment includes the steps of stacking the insulating layer 12 on the stainless steel foil 11; and forming the conductor layer 13 to touch the second surface 12b of the insulating layer 12. The order in which these two steps are performed is not specifically limited. For example, stacking the insulating layer 12 on the stainless steel foil 11 may be performed first, followed by formation of the conductor layer 13 on the insulating layer 12, or the reverse is possible. Alternatively, the stainless steel foil 11, the insulating layer 12 and the conductor layer 13 that have been separately formed may be stacked and then subjected to bonding at the same time. In the case of bonding the stainless steel foil 11, the insulating layer 12 and the conductor layer 13 at the same time, the foregoing two steps are performed at the same time.

As in the first embodiment, how to stack the insulating layer 12 on the stainless steel foil 11 is not specifically limited. For example, the insulating layer 12 made of resin may be formed by casting on the stainless steel foil 11, or the insulating layer 12 may be formed by laminating a resin film on the stainless steel foil 11.

How to form the conductor layer 13 is not specifically limited, either. For example, the conductor layer 13 may be formed by bonding a conductor foil to be the conductor layer 13 to the insulating layer 12, or the conductor layer 13 may be formed by a technique such as sputtering or plating on the second surface 12b of the insulating layer 12.

In the case of producing the flexure 2 or the suspension body through the use of the laminate 20 according to the present embodiment, the wiring 4 is formed by patterning the conductor layer 13 by, for example, etching. The laminate 20 is processed into a predetermined shape by a technique such as etching so as to become the flexure 2 or the suspension body.

In each of the laminate 10 according to the first embodiment and the laminate 20 according to the second embodiment, the stainless steel foil 11 is one that contains a martensite phase in a volume fraction of 0.4 to 2.5 volume %. In addition, each of the method for producing the laminate 10 according to the first embodiment and the method for producing the laminate 20 according to the second embodiment includes the step of selecting, as the stainless steel foil 11, one that contains a martensite phase of 0.4 to 2.5 volume %. According to the first embodiment, by the use of a stainless steel foil that contains a martensite phase of 0.4 to 2.5 volume % as the stainless steel foil 11, it is possible to suppress the warpage of the laminate 10 when the conductor layer 13 is stacked on the insulating layer 12. According to the second embodiment, it is possible to suppress the warpage of the laminate 20 by the use of a stainless steel foil that contains a martensite phase of 0.4 to 2.5 volume % as the stainless steel foil 11. A description will be given later as to the reason why it is possible to suppress the warpage of the laminates 10 and 20 by the use of a stainless steel foil that contains a martensite phase of 0.4 to 2.5 volume % as the stainless steel foil 11 as mentioned above.

In each of the embodiments, the stainless steel foil 11 is preferably one made of austenitic stainless steel containing the martensite phase.

In each of the embodiments, the stainless steel foil 11 preferably contains Ni of 7 to 13 weight % and Cr of 16 to 20 weight %. This makes it possible to allow both the modulus of elasticity and the strength of the stainless steel foil 11 to fall within respective preferable ranges when the thickness of the stainless steel foil 11 is within a preferable range to be described later.

In each of the embodiments, the insulating layer 12 is preferably made of a polyimide resin. In addition, in each of the embodiments, the conductor layer 13 preferably contains pure copper or a copper alloy.

In each of the embodiments, the thickness of the stainless steel foil 11 is preferably within a range of 10 to 100 μm. If the thickness of the stainless steel foil 11 is less than 10 μm, the strength of the suspension produced through the use of the laminate 10 or 20 may be insufficient. On the other hand, if the thickness of the stainless steel foil 11 exceeds 100 μm, the suspension produced through the use of the laminate 10 or 20 may become too great in weight and the power consumption of an actuator for driving the suspension may be excessively high, accordingly. It is more preferable that the thickness of the stainless steel foil 11 be within a range of 15 to 51 μm.

In each of the embodiments, the insulating layer 12 preferably has a thickness within a range of 5 to 50 μm, and more preferably within a range of 5 to 20 μm. In addition, in each of the embodiments, the conductor layer 13 preferably has a thickness within a range of 5 to 50 μm, and more preferably within a range of 5 to 18 μm. Each of these preferable ranges is intended to allow the thickness of the suspension produced through the use of the laminate 10 or 20 to fall within a typical suspension thickness range.

In each of the embodiments, the value obtained by dividing the thickness of the insulating layer 12 by the thickness of the stainless steel foil 11 is preferably within a range of 0.09 to 1.00. In addition, in each of the embodiments, the value obtained by dividing the thickness of the conductor layer 13 by the thickness of the stainless steel foil 11 is preferably within a range of 0.09 to 2.50.

In each of the embodiments, the insulating layer 12 preferably has a coefficient of linear thermal expansion within a range of 10×10⁻⁶ to 30×10⁻⁶. In addition, in each of the embodiments, the conductor layer 13 preferably has a coefficient of linear thermal expansion within a range of 10×10⁻⁶ to 30×10⁻⁶. If at least one of the coefficient of linear thermal expansion of the insulating layer 12 and that of the conductor layer 13 falls outside the above-mentioned preferable range, the laminates 10 and 20 may become poor in dimensional stability during processing thereof, which may result in warpage or deformation of the laminates 10 and 20. It is more preferred that the coefficient of linear thermal expansion of the insulating layer 12 be within a range of 15×10⁻⁶ to 25×10⁻⁶. In addition, it is more preferred that the coefficient of linear thermal expansion of the conductor layer 13 be within a range of 17×10⁻⁶ to 20×10⁻⁶.

A description will now be given of the reason why the use of a stainless steel foil that contains a martensite phase of 0.4 to 2.5 volume % as the stainless steel foil 11 enables suppression of the warpage of the laminate 10 when the conductor layer 13 is stacked on the insulating layer 12, and the warpage of the laminate 20. The inventors of the present application have found by an experiment that there is a correlation between the volume fraction of the martensite phase in the stainless steel foil 11 and the coefficient of linear thermal expansion of the stainless steel foil 11, and that there is a correlation between the volume fraction of the martensite phase in the stainless steel foil 11 and the warpage of the laminates 10 and 20. The inventors have also considered that one of the causes of the warpage of the laminates 10 and 20 would be the differences among the respective coefficients of linear thermal expansion of the stainless steel foil 11, the insulating layer 12 and the conductor layer 13. Based on these, the inventors have conceived that it would be possible to suppress the warpage of the laminates 10 and 20 by controlling the volume fraction of the martensite phase in the stainless steel foil 11, and, as a result of conducting the experiment, the inventors have found that the warpage of the laminates 10 and 20 can be suppressed by using a stainless steel foil that contains a martensite phase of 0.4 to 2.5 volume %, as the stainless steel foil 11.

It should be noted that the stainless steel foil 11 has a modulus of elasticity higher than that of the insulating layer 12 and that of the conductor layer 13. Accordingly, the magnitude of warpage of the laminates 10 and 20 changes greatly if the coefficient of linear thermal expansion of the stainless steel foil 11 changes. In contrast, the magnitude of warpage of the laminates 10 and 20 does not greatly change if the coefficients of linear thermal expansion of the insulating layer 12 and the conductor layer 13 or the thicknesses of the insulating layer 12 and the conductor layer 13 change within their preferable ranges mentioned previously. In order to suppress the warpage of the laminates 10 and 20, it is therefore important to control the coefficient of linear thermal expansion of the stainless steel foil 11. According to the present invention, the warpage of the laminates 10 and 20 is suppressed by controlling the coefficient of linear thermal expansion of the stainless steel foil 11 by controlling the volume fraction of the martensite phase in the stainless steel foil 11.

### EXAMPLES

Hereinafter, Examples and Comparative examples fabricated in the experiment will be described. While the Examples correspond to the second embodiment, the present invention is not limited to the Examples described below. First, methods for measuring various properties of the Examples and the Comparative examples will be described. Note that a polyimide resin used for each of the Examples and the Comparative examples was one in which imidization reaction had substantially completed.

[Method for Measuring the Volume Fraction of Martensite Phase in Stainless Steel Foil]

Ten pieces of stainless steel foil 11 were stacked into a rectangular sheet of 30 mm in length and 30 mm in width. This sheet was measured for ferrite content using a FERITSCOPE (trade name) from Fischer Instruments K.K., and the value obtained was taken as the volume fraction of the martensite phase in the stainless steel foil 11.

[Method for Measuring the Warpage of Laminate]

The laminate 20 was cut with a cutting machine into an A4-size sheet. This sheet was placed on a table, and then a portion of the sheet that came to a highest level from the desk top was measured for height from the desk top using a vernier caliper. The height was taken as the amount of warpage of the laminate 20.

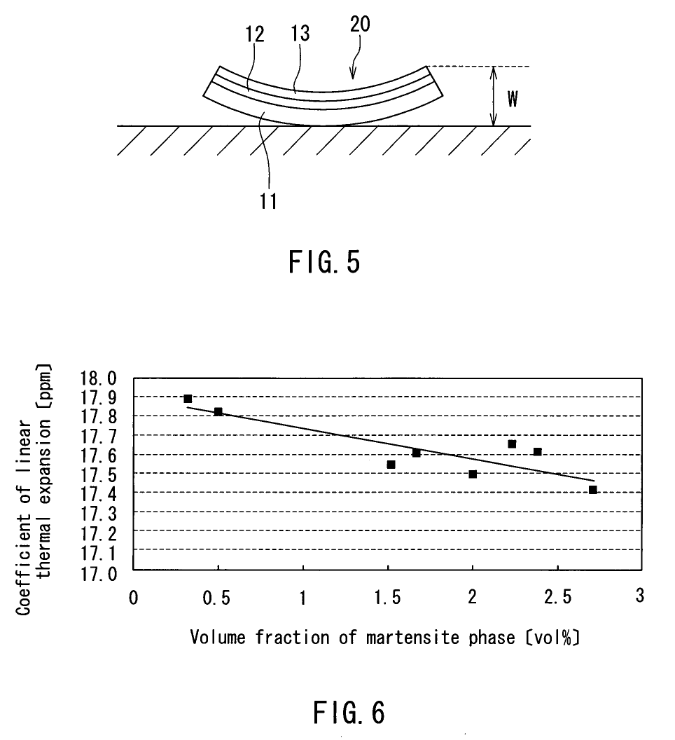

It should be noted that the laminate 20 can warp in either of the following two forms. A first form is such that, as shown in FIG. 4, when the laminate 20 is placed on a table with the stainless steel foil 11 down, the center portion of the laminate 20 is higher. In the experiment, the amount of warpage W in the first form was expressed in positive values. A second form is such that, as shown in FIG. 5, when the laminate 20 is placed on a table with the stainless steel foil 11 down, the peripheral portion of the laminate 20 is higher. In the experiment, the amount of warpage W in the second form was expressed in negative values.

[Method for Measuring the Coefficient of Linear Thermal Expansion of Stainless Steel Foil]

A thermomechanical analyzer from Seiko Instruments Inc. was used. The stainless steel foil 11 was raised in temperature up to 255° C., stored at that temperature for 10 minutes, and then cooled down at a rate of 5° C./min to determine an average value of the coefficients of linear thermal expansion of the stainless steel foil 11 in a range of 240° C. to 50° C. This average value was taken as the coefficient of linear thermal expansion of the stainless steel foil 11.

In the following description, abbreviations listed below will be used. Their meanings are as follows:
PMDA: pyromellitic dianhydride;
DSDA: 3,4,3′,4′-diphenylsulfonetetracarboxylic dianhydride;
BPDA: 3,3′,4,4′-biphenyltetracarboxylic dianhydride;
MABA: 4,4′-diamino-2′-methoxybenzanilide;
DAPE: 4,4′-diaminodiphenyl ether;
PDA: p-phenylenediamine;
APB: 1,3-bis-(3-aminophenoxy)benzene;
BAPS: bis(4-aminophenoxy)sulfone;
BAPP: 2,2′-bis[4-(4-aminophenoxy)phenyl]propane; and
DMAc: N,N-dimethylacetamide.

To produce the laminates of the Examples and the Comparative examples, solutions of four types of polyimide precursors A, B, C and D were prepared according to the following Synthesis examples 1 to 4.

### Synthesis Example 1

In Synthesis example 1, initially, MABA of 154.4 g (0.60 mol) and DAPE of 80.1 g (0.40 mol) were dissolved in DMAc of 2560 g while being stirred in a 5-liter separable flask. Next, PMDA of 218.1 g (1 mol) was added to the solution in a nitrogen gas stream. Subsequently, the reaction mixture was stirred continuously for three hours for polymerization, and a viscous solution of the polyimide precursor A was thereby obtained.

### Synthesis Example 2

PDA of 75.7 g (0.70 mol) and DAPE of 60.1 g (0.30 mol) were dissolved in DMAc of 2010 g while being stirred in a 5-liter separable flask. Next, PMDA of 218.1 g (1 mol) was added to the solution in a nitrogen gas stream. Subsequently, the reaction mixture was stirred continuously for three hours for polymerization, and a viscous solution of the polyimide precursor B was thereby obtained.

### Synthesis Example 3

APB of 292.3 g (1 mol) was dissolved in DMAc of 3690 g while being stirred in a 5-liter separable flask. Next, DSDA of 358.3 g (1 mol) was added to the solution in a nitrogen gas stream. Subsequently, the reaction mixture was stirred continuously for three hours for polymerization, and a viscous solution of the polyimide precursor C was thereby obtained.

### Synthesis Example 4

BAPP of 414.2 g (1 mol) was dissolved in DMAc of 3486 g while being stirred in a 5-liter separable flask. Next, BPDA of 299.8 g (1 mol) was added to the solution in a nitrogen gas stream. Subsequently, the reaction mixture was stirred continuously for three hours for polymerization, and a viscous solution of the polyimide precursor D was thereby obtained.

The solutions obtained according to the above-described Synthesis examples 1 to 4 were used to produce the laminates of the following Examples and Comparative examples.

### Example 1

The laminate 20 of Example 1 was produced as described below. Initially, a stainless steel foil 11 containing a martensite phase in a volume fraction of 0.50 volume % and having a coefficient of linear thermal expansion of 17.82 ppm (ppm=×10⁻⁶) and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor C obtained in Synthesis example 3 was initially applied onto the stainless steel foil 11 to a cured thickness of 1 μm, and drying was performed at 110° C. for three minutes. Next, the solution of the polyimide precursor A obtained in Synthesis example 1 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, a 12-μm-thick rolled copper foil (NK120 (product name) from Nikko Materials Co., Ltd.) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 10 μm in thickness and the conductor layer 13 (copper foil layer) of 12 μm in thickness was produced.

### Example 2

The laminate 20 of Example 2 was produced as described below. Initially, a stainless steel foil 11 containing a martensite phase in a volume fraction of 1.52 volume % and having a coefficient of linear thermal expansion of 17.55 ppm and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor C obtained in Synthesis example 3 was initially applied onto the stainless steel foil 11 to a cured thickness of 1 μm, and drying was performed at 110° C. for three minutes. Next, the solution of the polyimide precursor A obtained in Synthesis example 1 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, a 12-μm-thick rolled copper foil (NK120 (product name) from Nikko Materials Co., Ltd.) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 10 μm in thickness and the conductor layer 13 (copper foil layer) of 12 μm in thickness was produced.

### Example 3

The laminate 20 of Example 3 was produced as described below. Initially, a stainless steel foil 11 containing a martensite phase in a volume fraction of 2.38 volume % and having a coefficient of linear thermal expansion of 17.62 ppm and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor C obtained in Synthesis example 3 was initially applied onto the stainless steel foil 11 to a cured thickness of 1 μm, and drying was performed at 110° C. for three minutes. Next, the solution of the polyimide precursor A obtained in Synthesis example 1 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, a 12-μm-thick rolled copper foil (NK120 (product name) from Nikko Materials Co., Ltd.) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 10 μm in thickness and the conductor layer 13 (copper foil layer) of 12 μm in thickness was produced.

### Example 4

The laminate 20 of Example 4 was produced as described below. Initially, a stainless steel foil 11 containing a martensite phase in a volume fraction of 1.67 volume % and having a coefficient of linear thermal expansion of 17.61 ppm and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor D obtained in Synthesis example 4 was initially applied onto the stainless steel foil 11 to a cured thickness of 1 μm, and drying was performed at 110° C. for three minutes. Next, the solution of the polyimide precursor B obtained in Synthesis example 2 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, an 18-μm-thick rolled copper foil (C7025 (product name) from Olin Corporation) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 10 μm in thickness and the conductor layer 13 (copper foil layer) of 18 μm in thickness was produced.

### Example 5

The laminate 20 of Example 5 was produced as described below. Initially, a stainless steel foil 11 containing a martensite phase in a volume fraction of 2.00 volume % and having a coefficient of linear thermal expansion of 17.50 ppm and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor D obtained in Synthesis example 4 was initially applied onto the stainless steel foil 11 to a cured thickness of 1 μm, and drying was performed at 110° C. for three minutes. Next, the solution of the polyimide precursor B obtained in Synthesis example 2 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, an 18-μm-thick rolled copper foil (NK120 (product name) from Nikko Materials Co., Ltd.) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 10 μm in thickness and the conductor layer 13 (copper foil layer) of 18 μm in thickness was produced.

### Example 6

The laminate 20 of Example 6 was produced as described below. Initially, a stainless steel foil 11 containing a martensite phase in a volume fraction of 2.23 volume % and having a coefficient of linear thermal expansion of 17.66 ppm and a thickness of 25 μm (from Nippon Steel Corporation, SUS304, tension-annealed) was prepared. Next, an insulating layer 12 was formed on the stainless steel foil 11 by casting in the following manner. That is, the solution of the polyimide precursor D obtained in Synthesis example 4 was initially applied onto the stainless steel foil 11 to a cured thickness of 1 μm, and drying was performed at 110° C. for three minutes. Next, the solution of the polyimide precursor B obtained in Synthesis example 2 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, a 12-μm-thick rolled copper foil (NK120 (product name) from Nikko Materials Co., Ltd.) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 25 μm in thickness, the insulating layer 12 (polyimide resin layer) of 10 μm in thickness and the conductor layer 13 (copper foil layer) of 12 μm in thickness was produced.

### Example 7

The laminate 20 of Example 7 was produced as described below. Initially, a stainless steel foil 11 containing a martensite phase in a volume fraction of 2.23 volume % and having a coefficient of linear thermal expansion of 17.66 ppm and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor D obtained in Synthesis example 4 was initially applied onto the stainless steel foil 11 to a cured thickness of 1 μm, and drying was performed at 110° C. for three minutes. Next, the solution of the polyimide precursor B obtained in Synthesis example 2 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, a 12-μm-thick electrolytic copper foil (F2-WS (product name) from The Furukawa Electric Co., Ltd.) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 10 μm in thickness and the conductor layer 13 (copper foil layer) of 12 μm in thickness was produced.

### Example 8

The laminate 20 of Example 8 was produced as described below. Initially, a stainless steel foil 11 containing a martensite phase in a volume fraction of 2.23 volume % and having a coefficient of linear thermal expansion of 17.66 ppm and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor D obtained in Synthesis example 4 was initially applied onto the stainless steel foil 11 to a cured thickness of 1 μm, and drying was performed at 110° C. for three minutes. Next, the solution of the polyimide precursor B obtained in Synthesis example 2 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, a conductor layer 13 was formed on the second surface 12b of the insulating layer 12 by sputtering and plating as described below. Initially, a laminate composed of the stainless steel foil 11 and the insulating layer 12 was placed in a chamber of a DC magnetron sputtering system. Next, the internal pressure of the chamber was reduced to 1×10⁻³ Pa. Then, argon gas was introduced into the chamber and plasma was generated with a DC power supply, so that a 4-nm-thick nickel film was formed on the second surface 12b of the insulating layer 12 by sputtering. Next, in the same atmosphere, a 300-nm-thick copper sputter film was formed on the nickel film by sputtering. Next, using this copper sputter film as an electrode, a 9-μm-thick copper plating layer was formed by electrolytic plating on the copper sputter film. Here, a copper sulfate solution (100 g/L copper sulfate, 200 g/L sulfuric acid, and 40 mg/L chlorine) was used for the plating bath and phosphor-containing copper was used as an anode, with a current density of 2.0 A/dm². The conductor layer 13 formed through the foregoing steps is composed of the nickel film, the copper supper film and the copper plating layer. In this way, the laminate 20 composed of the stainless steel foil 11 of 20 μm in thickness, the insulating layer 12 (polyimide resin layer) of 10 μm in thickness and the conductor layer 13 of approximately 9 μm in thickness was produced.

### Example 9

The laminate 20 of Example 9 was produced as described below. Initially, the solution of the polyimide precursor D obtained in Synthesis example 4 was applied onto one surface of a 12.5-μm-thick commercially available non-thermoplastic polyimide film (Kapton EN (trade name) from Du Pont-Toray Co., Ltd.) to a cured thickness of 2 μm, and drying was performed at 110° C. for three minutes. Next, the solution of the polyimide precursor D obtained in Synthesis example 4 was applied onto the other surface of the above-mentioned non-thermoplastic polyimide film to a cured thickness of 2 μm, and drying was performed at 110° C. for three minutes. Next, heat treatment was performed stepwise in a range of 130° C. to 360° C. to complete imidization, and a 16.5-μm-thick polyimide film having a three-layer structure was thereby formed. This polyimide film serves as the insulating layer 12 and is to be laminated on the stainless steel foil 11 later.

Next, prepared were a stainless steel foil 11 containing a martensite phase in a volume fraction of 2.23 volume % and having a coefficient of linear thermal expansion of 17.66 ppm and a thickness of 20 μm (from Nippon Steel Corporation, SUS304, tension-annealed), and a 12-μm-thick rolled copper foil (NK120 (product name) from Nikko Materials Co., Ltd.) to be the conductor layer 13. Next, the stainless steel foil 11, the insulating layer 12 and the rolled copper foil were stacked such that the stainless steel foil 11 touches the first surface 12a of the insulating layer 12 (polyimide film) formed by the foregoing method while the rolled copper foil touches the second surface 12b of the insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 16.5 μm in thickness and the conductor layer 13 (copper foil layer) of 12 μm in thickness was produced.

### Comparative Example 1

The laminate 20 of Comparative example 1 was produced as described below. Initially, a stainless steel foil 11 containing a martensite phase in a volume fraction of 0.30 volume % and having a coefficient of linear thermal expansion of 17.89 ppm and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor C obtained in Synthesis example 3 was initially applied onto the stainless steel foil 11 to a cured thickness of 1 μm, and drying was performed at 110° C. for three minutes. Next, the solution of the polyimide precursor A obtained in Synthesis example 1 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, a 12-μm-thick rolled copper foil (NK120 (product name) from Nikko Materials Co., Ltd.) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 10 μm in thickness and the conductor layer 13 (copper foil layer) of 12 μm in thickness was produced.

### Comparative Example 2

The laminate 20 of Comparative example 2 was produced as described below. Initially, a stainless steel foil 11 containing a martensite phase in a volume fraction of 2.71 volume % and having a coefficient of linear thermal expansion of 17.42 ppm and a thickness of 20 μm (from Nippon Steel Corporation, SUS304, tension-annealed) was prepared. Next, an insulating layer 12 was formed on the stainless steel foil 11 by casting in the following manner. That is, the solution of the polyimide precursor C obtained in Synthesis example 3 was initially applied onto the stainless steel foil 11 to a cured thickness of 1 μm, and drying was performed at 110° C. for three minutes. Next, the solution of the polyimide precursor A obtained in Synthesis example 1 was applied thereonto to a cured thickness of 7 μm, and drying was performed at 110° C. for 10 minutes. Next, the solution of the polyimide precursor C obtained in Synthesis example 3 was applied thereonto to a cured thickness of 2 μm, and drying was performed at 110° C. for three minutes. Next, heat treatment was performed stepwise in a range of 130° C. to 360° C. to complete imidization, and a 10-μm-thick polyimide resin layer was thereby formed as the insulating layer 12 on the stainless steel foil 11.

Next, a 12-μm-thick rolled copper foil (NK120 (product name) from Nikko Materials Co., Ltd.) to be the conductor layer 13 was stacked on the foregoing insulating layer 12, and thermocompression bonding was performed using a vacuum press machine at a surface pressure of 15 MPa and a temperature of 320° C., and with a press time of 20 minutes. As a result, the laminate 20 composed of the stainless steel foil 11 of 20 μm in thickness, the insulating layer 12 (polyimide resin layer) of 10 μm in thickness and the conductor layer 13 (copper foil layer) of 12 μm in thickness was produced.

In the experiment, the laminates 20 of the foregoing Examples and Comparative examples were measured for the amount of warpage. The following two tables summarize each of the Examples and the Comparative examples, and show the measurements on the amount of warpage. The following two tables also show the coefficients of linear thermal expansion of the insulating layer 12 and the conductor layer 13, and the moduli of elasticity of the stainless steel foil 11, the insulating layer 12 and the conductor layer 13. The blank columns in the tables indicate that no measurement was performed thereon.

TABLE 1

| | Example 1 | Example 2 | Example 3 | Example 4 | Example 5 |
|---|---|---|---|---|---|
| Forming method | Casting | Casting | Casting | Casting | Casting |
| for insulating layer | | | | | |
| Forming method | Rolled Cu | Rolled Cu | Rolled Cu | Rolled Cu | Rolled Cu |
| for conductor layer | foil | foil | foil | foil | foil |
| Stainless steel foil | 20 | 20 | 20 | 20 | 20 |
| thickness (μm) | | | | | |
| Insulating layer | 10 | 10 | 10 | 10 | 10 |
| thickness (μm) | | | | | |
| Conductor layer | 12 | 12 | 12 | 18 | 18 |
| thickness (μm) | | | | | |
| Volume fraction of | 0.50 | 1.52 | 2.38 | 1.67 | 2.00 |
| martensite phase in | | | | | |
| stainless steel foil | | | | | |
| Coefficient of linear | 17.82 | 17.55 | 17.62 | 17.61 | 17.50 |
| thermal expansion | | | | | |
| of stainless steel foil (ppm) | | | | | |
| Coefficient of linear | 21 | 21 | 21 | 21 | 21 |
| thermal expansion | | | | | |
| of insulating layer (ppm) | | | | | |
| Coefficient of linear | 17.4 | 17.4 | 17.4 | 17.5 | 17.6 |
| thermal expansion | | | | | |
| of conductor layer (ppm) | | | | | |
| Modulus of elasticity | 193 | 193 | 193 | 193 | 193 |
| of stainless steel foil (GPa) | | | | | |
| Modulus of elasticity | 4.5 | 4.5 | 4.5 | 5.5 | 5.5 |
| of insulating layer (GPa) | | | | | |
| Modulus of elasticity | 129 | 129 | 129 | 133 | 129 |
| of conductor layer (GPa) | | | | | |
| Amount of warpage | 3.11 | −1.80 | −3.65 | −1.22 | −1.85 |
| of laminate (mm) | | | | | |

TABLE 2

| | | | | | Compar. | Compar. |
|---|---|---|---|---|---|---|
| | Example 6 | Example 7 | Example 8 | Example 9 | example 1 | example 2 |
| Forming method | Casting | Casting | Casting | Lamination | Casting | Casting |
| for insulating layer | | | | | | |
| Forming method | Rolled | Electrolytic | Sputtering | Rolled | Rolled Cu | Rolled Cu |
| for conductor layer | Cu foil | Cu | and | Cu foil | foil | foil |
| | | foil | plating | | | |
| Stainless steel foil | 25 | 20 | 20 | 20 | 20 | 20 |
| thickness (μm) | | | | | | |
| Insulating layer | 10 | 10 | 10 | 16.5 | 10 | 10 |
| thickness (μm) | | | | | | |
| Conductor layer | 12 | 12 | 9 | 12 | 12 | 12 |
| thickness (μm) | | | | | | |
| Volume fraction of | 2.23 | 2.23 | 2.23 | 2.23 | 0.32 | 2.71 |
| martensite phase in | | | | | | |
| stainless steel foil | | | | | | |
| Coefficient of linear | 17.66 | 17.66 | 17.66 | 17.66 | 17.89 | 17.42 |
| thermal expansion | | | | | | |
| of stainless steel | | | | | | |
| foil (ppm) | | | | | | |
| Coefficient of linear | 21 | 21 | 21 | 21 | 21 | 21 |
| thermal expansion | | | | | | |
| of insulating layer | | | | | | |
| (ppm) | | | | | | |
| Coefficient of linear | 17.4 | 17.4 | 17 | 17.4 | 17.4 | 17.4 |
| thermal expansion | | | | | | |
| of conductor layer | | | | | | |
| (ppm) | | | | | | |
| Modulus of elasticity | 193 | 193 | 193 | 193 | 193 | 193 |
| of stainless steel | | | | | | |
| foil (GPa) | | | | | | |
| Modulus of elasticity | 5.5 | 5.5 | 5.5 | — | 4.5 | 4.5 |
| of insulating | | | | | | |
| layer (GPa) | | | | | | |
| Modulus of elasticity | 129 | 110 | — | 129 | 129 | 129 |
| of conductor | | | | | | |
| layer (GPa) | | | | | | |
| Amount of warpage | −3.25 | −3.41 | −0.76 | −3.70 | 4.02 | −5.21 |
| of laminate (mm) | | | | | | |

FIG. 6 shows the relationship between the volume fraction of the martensite phase in the stainless steel foil 11 and the coefficient of linear thermal expansion thereof in the Examples and the Comparative examples. From FIG. 6, it can be seen that there is a correlation between the volume fraction of the martensite phase in the stainless steel foil 11 and the coefficient of linear thermal expansion of the stainless steel foil 11. More specifically, at least within the range of volume faction of the martensite phase shown in FIG. 6, the coefficient of linear thermal expansion seems to decrease with increasing volume fraction of the martensite phase.

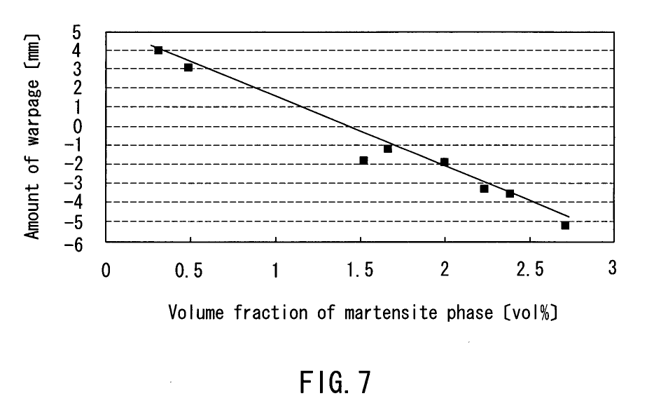

FIG. 7 shows the relationship between the volume fraction of the martensite phase in the stainless steel foil 11 and the amount of warpage of the laminate 20 in the Examples and the Comparative examples. It should be noted that while Examples 6 to 9 have equal volume fractions of the martensite phase, the amounts of warpage of the laminates 20 are different. This is presumably attributable to the differences in the formation method for the insulating layer 12 or the formation method for the conductor layer 13. Among the amounts of warpage for Examples 6 to 9, FIG. 7 shows the amount of warpage for Example 6 in which the formation methods for the insulating layer 12 and the conductor layer 13 were the same as those of Examples 1 to 5. From FIG. 7, it can be seen that there is a correlation between the volume fraction of the martensite phase in the stainless steel foil 11 and the amount of warpage of the laminate 20. More specifically, within the range of volume fraction of the martensite phase shown in FIG. 7, the amount of warpage seems to decrease in value, including the positive and negative signs, with increasing volume fraction of the martensite phase.

It should be noted that the absolute value of the amount of warpage for Example 8, among Examples 6 to 9, is smaller than the absolute value of the amount of warpage for each of Examples 6, 7 and 9. A possible reason for this is as follows. In Examples 6, 7 and 9, the insulating layer 12 and the conductor layer 13 are bonded to each other by thermocompression bonding. Accordingly, in Examples 6, 7 and 9, the stainless steel foil 11, the insulating layer 12 and the conductor layer 13 undergo great temperature changes in the production process of the laminate 20, and the amounts of expansion and contraction of the stainless steel foil 11, the insulating layer 12 and the conductor layer 13 due to the temperature changes are therefore great, too, which presumably results in a great absolute value of the amount of warpage. In Example 8, in contrast, the conductor layer 13 is formed by sputtering and plating on the insulating layer 12. Accordingly, in Example 8, as compared with Examples 6, 7 and 9, temperature changes in the stainless steel foil 11, the insulating layer 12 and the conductor layer 13 in the production process of the laminate 20 are smaller and the amounts of expansion and contraction of the stainless steel foil 11, the insulating layer 12 and the conductor layer 13 caused by the temperature changes are also smaller, which presumably results in a smaller absolute value of the amount of warpage.

To eliminate problems resulting from the warpage of the laminate 20 in the production process of a suspension, it is preferred that the magnitude of warpage, that is, the absolute value of the amount of warpage, be 4 mm or smaller when measured with an A4-size laminate 20. As FIG. 7 indicates, it is possible to make the absolute value of the amount of warpage of the laminate 20 equal to or smaller than 4 mm by making the volume fraction of the martensite phase in the stainless steel foil 11 fall within a range of 0.4 to 2.5 volume %. Accordingly, in the present invention, a stainless steel foil containing a martensite phase of 0.4 to 2.5 volume % is used as the stainless steel foil 11. It is thereby possible to suppress the warpage of the laminate 20.

If the conductor layer 13 is formed on the insulating layer 12 of the laminate 10 according to the first embodiment, the configuration of the laminate 10 becomes the same as that of the laminate 20 according to the second embodiment. Therefore, it is also possible for the laminate 10 according to the first embodiment to suppress the warpage of the laminate 10 when the conductor layer 13 is stacked on the insulating layer 12, by making the volume fraction of the martensite phase in the stainless steel foil 11 fall within the range of 0.4 to 2.5 volume %.

The present invention is not limited to the foregoing embodiments, and various modifications can be made thereto. For example, the methods for producing the laminates 10 and 20 described in the embodiments are given only by way of example, and the method for producing the laminate according to the invention is not limited thereto.

1. A laminate for a suspension used for producing a wiring-integrated suspension that flexibly supports a slider including a magnetic head such that the slider is opposed to a recording medium,
the laminate for a suspension comprising a stainless steel foil, and an insulating layer stacked on the stainless steel foil,
wherein the stainless steel foil contains a martensite phase of 0.4 to 2.5 volume %.

2. The laminate for a suspension according to claim 1, wherein the stainless steel foil is made of austenitic stainless steel containing the martensite phase.

3. The laminate for a suspension according to claim 1, wherein the stainless steel foil contains Ni of 7 to 13 weight % and Cr of 16 to 20 weight %.

4. The laminate for a suspension according to claim 1, wherein the insulating layer is made of a polyimide resin.

5. The laminate for a suspension according to claim 1, wherein the stainless steel foil has a thickness within a range of 10 to 100 μm, and the insulating layer has a thickness within a range of 5 to 50 μm.

6. The laminate for a suspension according to claim 1, wherein the insulating layer has a coefficient of linear thermal expansion within a range of 10×10⁻⁶ to 30×10⁻⁶.

7. The laminate for a suspension according to claim 1, wherein the insulating layer has a first surface touching the stainless steel foil and a second surface opposite thereto,
the laminate for a suspension further comprising a conductor layer disposed to touch the second surface of the insulating layer.

8. The laminate for a suspension according to claim 7, wherein the stainless steel foil has a thickness within a range of 10 to 100 μm, the insulating layer has a thickness within a range of 5 to 50 μm, and the conductor layer has a thickness within a range of 5 to 50 μm.

9. The laminate for a suspension according to claim 7, wherein the insulating layer has a coefficient of linear thermal expansion within a range of 10×10⁻⁶ to 30×10⁻⁶, and the conductor layer has a coefficient of linear thermal expansion within a range of 10×10⁻⁶ to 30×10⁻⁶.

10. The laminate for a suspension according to claim 7, wherein the conductor layer contains pure copper or a copper alloy.

11. A method for producing a laminate for a suspension, the laminate for a suspension being used for producing a wiring-integrated suspension that flexibly supports a slider including a magnetic head such that the slider is opposed to a recording medium, and comprising a stainless steel foil and an insulating layer stacked on the stainless steel foil, the method comprising the steps of:
selecting, as the stainless steel foil, one that contains a martensite phase of 0.4 to 2.5 volume %; and
stacking the insulating layer on the stainless steel foil selected.

12. The method for producing the laminate for a suspension according to claim 11, wherein the stainless steel foil is made of austenitic stainless steel containing the martensite phase.

13. The method for producing the laminate for a suspension according to claim 11, wherein the stainless steel foil contains Ni of 7 to 13 weight % and Cr of 16 to 20 weight %.

14. The method for producing the laminate for a suspension according to claim 11, wherein the insulating layer is made of a polyimide resin.

15. The method for producing the laminate for a suspension according to claim 11, wherein the stainless steel foil has a thickness within a range of 10 to 100 μm, and the insulating layer has a thickness within a range of 5 to 50 μm.

16. The method for producing the laminate for a suspension according to claim 11, wherein the insulating layer has a coefficient of linear thermal expansion within a range of 10×10⁻⁶ to 30×10⁻⁶.

17. The method for producing the laminate for a suspension according to claim 11, wherein the insulating layer has a first surface touching the stainless steel foil and a second surface opposite thereto, the laminate for a suspension further comprising a conductor layer disposed to touch the second surface of the insulating layer,
the method further comprising the step of forming the conductor layer.

18. The method for producing the laminate for a suspension according to claim 17, wherein the stainless steel foil has a thickness within a range of 10 to 100 μm, the insulating layer has a thickness within a range of 5 to 50 μm, and the conductor layer has a thickness within a range of 5 to 50 μm.

19. The method for producing the laminate for a suspension according to claim 17, wherein the insulating layer has a coefficient of linear thermal expansion within a range of 10×10⁻⁶ to 30×10⁻⁶, and the conductor layer has a coefficient of linear thermal expansion within a range of 10×10⁻⁶ to 30×10⁻⁶.

20. The method for producing the laminate for a suspension according to claim 17, wherein the conductor layer contains pure copper or a copper alloy.
